(19) United States
(12) Patent Application Publication
(10) Pub. No.: US 2013/0240435 A1
(43) Pub. Date: Sep. 19, 2013

(54) UNIVERSAL FILTER

(71) Applicant: TECHTRONIC POWER TOOLS TECHNOLOGY LIMITED, Tortola (VG)

(72) Inventor: John Michael Plocic, Anderson, SC (US)

(73) Assignee: TECHTRONIC POWER TOOLS TECHNOLOGY LIMITED, Tortola (VG)

(21) Appl. No.: 13/786,929

(22) Filed: Mar. 6, 2013

Related U.S. Application Data
(60) Provisional application No. 61/611,761, filed on Mar. 16, 2012.

(51) Int. Cl. B01D 29/11

(52) U.S. Cl. CPC B01D 29/118
USPC 210/457

(57) ABSTRACT

A filter element for a paint sprayer having a feed line includes a core defining a first end, a second end, and a central portion extending along an axis between the first end and the second end. The central portion includes a central aperture closed at the first end and open at the second end and a plurality of openings that extend through the core to the central aperture. A mesh member surrounds the central portion and an adapter is coupled to the second end. The adapter includes a flowpath therethrough, an outer cylindrical surface, and an annular surface. The annular surface is operable to engage an end of the feed line such that the adapter is operable to form an axial seal between the adapter and the feed line.

### RELATED APPLICATION DATA

This application claims priority to U.S. Provisional Application No. 61/611,761 filed Mar. 16, 2012, the entire contents of which are incorporated herein by reference.

### BACKGROUND

Embodiments of the invention relate to filters for use with paint sprayers. More particularly, the invention relates to a universal filter for use with multiple paint sprayers.

Tools such as paint sprayers utilize spray guns to evenly apply paint to a surface. Paint sprayers utilize paint filters to ensure that debris or foreign objects are not sprayed or pulled into the paint sprayer. The filters prevent obstructions from clogging an outlet of the spray gun that could result in unevenness of the application.

### SUMMARY

Spray guns used in conjunction with paint sprayers have variable sized conduits that receive the paint filters. Accordingly, embodiments of the present invention provide a filter assembly. The filter assembly includes a filter having a threaded core encased in a mesh overlay. The core includes a main channel or aperture that receives paint through auxiliary openings or apertures. The filter has a first end that is closed and a second end that is open. The first end of the filter is coupled to a cap, while the second end of the filter is coupled to an adaptor. The adaptor maintains the opening in the main channel of the filter. The adaptor further includes a resilient flange that generates a fluidic seal with different sized conduits thereby allowing the filter assembly to be used with different types of paint sprayers.

In one construction, the invention provides a filter element for a paint sprayer having a feed line. The filter element includes a core defining a first end, a second end, and a central portion extending along an axis between the first end and the second end. The central portion includes a central aperture closed at the first end and open at the second end and a plurality of openings that extend through the core to the central aperture. A mesh member surrounds the central portion and an adapter is coupled to the second end. The adapter includes a flowpath therethrough, an outer cylindrical surface, and an annular surface. The annular surface is operable to engage an end of the feed line such that the adapter is operable to form an axial seal between the adapter and the feed line.

In another construction, the invention provides a filter element for use with a plurality of different-sized feed lines. The filter element includes a cylindrical filter including a closed end, an open end, and a central portion between the closed end and the opened end. An adapter is coupled to the second end. The adapter includes an outer cylindrical surface having an outside diameter and an annular surface that extends from the outside diameter to an outside flange diameter. The outer cylindrical surface and the feed line cooperate to form a radial seal when the feed line has an inside diameter that is substantially the same as the outside diameter. The annular surface and the feed line cooperate to form an axial seal when the inside diameter is larger than an inside diameter that is capable of forming a seal with the cylindrical surface.

In still another construction, the invention provides a filter element for use with a first paint sprayer having a first feed line and a second paint sprayer having a second feed line, the first feed line having a first inside diameter that is different than a second inside diameter of the second feed line. The filter element includes a core defining a first end, a second end, and a central portion extending along an axis between the first end and the second end. The central portion includes a central aperture closed at the first end and open at the second end and a plurality of openings that extend through the core to the central aperture. An adapter is coupled to the second end and includes a flowpath therethrough. The adapter includes an outer cylindrical surface having an outside diameter and an annular surface that extends from the outside diameter to an outside flange diameter. The first inside diameter is such that the first feed line and the outer cylindrical surface cooperate to define a radial seal, the second inside diameter being larger than the first inside diameter and not sealingly engageable with the outer cylindrical surface. An end of the second feed line sealingly engages the annular surface to form an axial seal between the second feed line and the adapter.

Other aspects of the invention will become apparent by consideration of the detailed description and accompanying drawings.

### BRIEF DESCRIPTION OF THE DRAWINGS

FIG. 1 is a perspective view of a filter assembly embodying the invention.

FIG. 2 is an exploded view of the filter assembly in FIG. 1.

FIG. 3 is a side view of a core included in the filter assembly in FIG. 1.

FIG. 4 is a cross-sectional view of the core of the filter assembly in FIG. 3 along 4-4.

FIG. 5 is a side view of an overlay included in the filter assembly in FIG. 1.

FIG. 6 is a cross-sectional view of a cap included in the filter assembly in FIG. 1.

FIG. 7 is a cross-sectional view of an adaptor included in the filter assembly in FIG. 1 with a first feed line attached.

FIG. 8 is a cross-sectional view of an adaptor included in the filter assembly in FIG. 1 with a second feed line attached.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

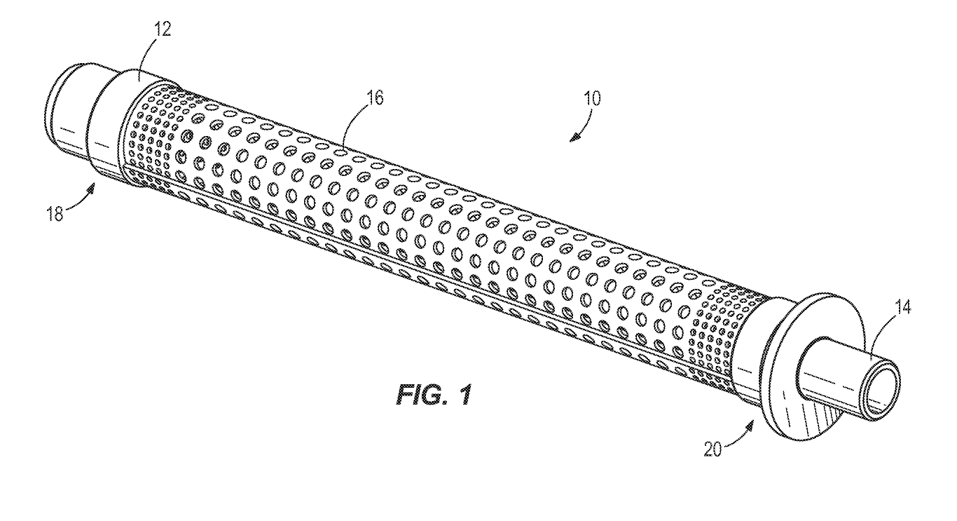

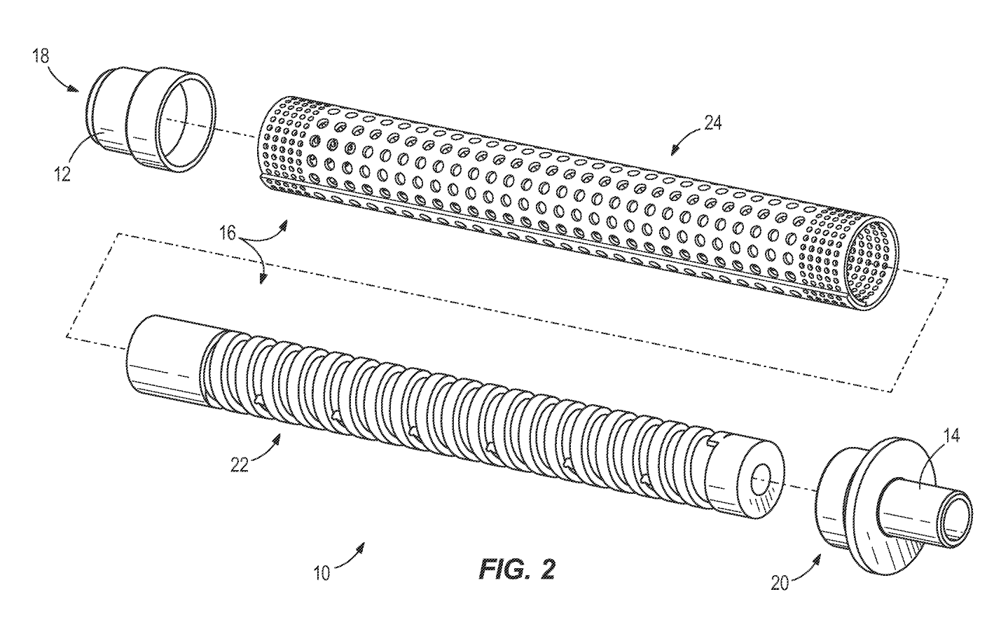

FIGS. 1 and 2 illustrate a filter assembly 10 that includes a cap 12, an adaptor 14, and a filter 16, therebetween. The filter assembly 10 is generally cylindrically shaped and includes a first end 18 and a second end 20. The filter assembly 10 includes a core 22 encased or contained within a mesh cover or overlay 24. The overlay 24 closely surrounds the core 22 from the first end 18 of the filter 16 to the second end 20 of the filter 16. The core 22 and overlay 24 are coupled to the cap 12 at the first end 18 of the filter assembly 10 and attached to the adaptor 14 at the second end 20 of the filter assembly 10.

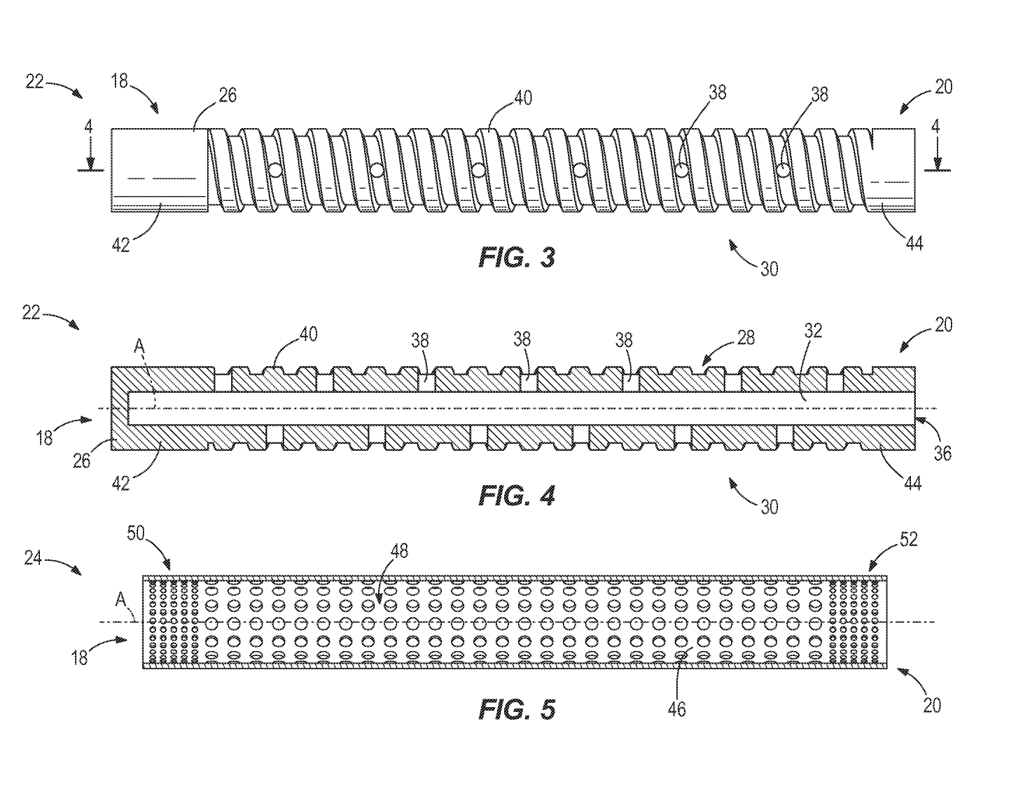

Referring to FIGS. 3 and 4, the core 22 includes a housing 26 that is preferably formed of a plastic material, and extends substantially from the first end 18 of the filter assembly 10 to the second end 20 of the filter assembly 10. The core 22 also includes a first side 28 and a second side 30. The core 22 defines a main aperture or channel 32. The channel 32 extends from the first end 18 of the filter assembly 10 to the second end 20 of the filter assembly 10 along axis A. The channel 32 includes a closed end or portion 34 at the first end 18 of the filter assembly 10 and an opening 36 at the second end 20 of the filter assembly 10. The core 22 includes a plurality of auxiliary apertures or openings 38 that access the main channel 36. The apertures 38 are oriented substantially perpendicular to the main channel 36. In the illustrated embodiment, the apertures 38 are staggered between the first and second sides 28, 30 of the core 22. In other embodiments, the apertures could be directly across from one another. Additionally, other embodiments could include more or less auxiliary apertures or apertures of different shapes, sizes, or orientations so long as the apertures are able to direct fluid to the channel 32.

Further with respect to FIGS. 3 and 4, the core 22 includes a threaded portion 40, a first unthreaded portion 42 at the first end 18, and a second unthreaded portion 44 at the second end 20. In the illustrated embodiment, the first unthreaded portion 42 makes up a larger portion of the housing 26 than the second unthreaded portion 44. It is contemplated that in future embodiments, the unthreaded portions relative to each other and relative to the threaded portion could be different or could have different dimensions and orientations. The closed end 34 of the channel 32 is within the first unthreaded portion 42, while the second unthreaded portion 44 surrounds the opening 36 in the main channel 32.

Referring to FIG. 5, the mesh overlay 24 (which encases the core 22) extends substantially the length of the core 22 along axis A. The mesh overlay 24 is preferably formed from plastic with metals or other materials also being suitable. The mesh overlay 24 wraps around the housing 26 so that a portion 46 of the overlay overlaps itself. The lattice of the mesh overlay 24 includes a portion 48 having large openings and portions 50, 52 having small openings. The large opening portion 48 is disposed between the first end 18 and the second end 20. As such, the large opening portion 48 substantially covers the threaded portion 40 of the core 22. A first small opening portion 50 covers the first end 18 of the core 22 and a second small opening portion 52 covers the second end 20 of the core 22. The portion 46 of the mesh overlay 24 includes small openings that are the result of the overlapping layers of the mesh material. The portion 46 having small openings, extends between the first and second ends 18, 20 of the filter assembly 10 along axis A. The dimensions, shapes and orientation of openings in the mesh overlay demonstrated in FIG. 5 are one possible embodiment of the lattice of the overlay, and in other embodiments, the openings may have any suitable dimensions, shapes and orientation.

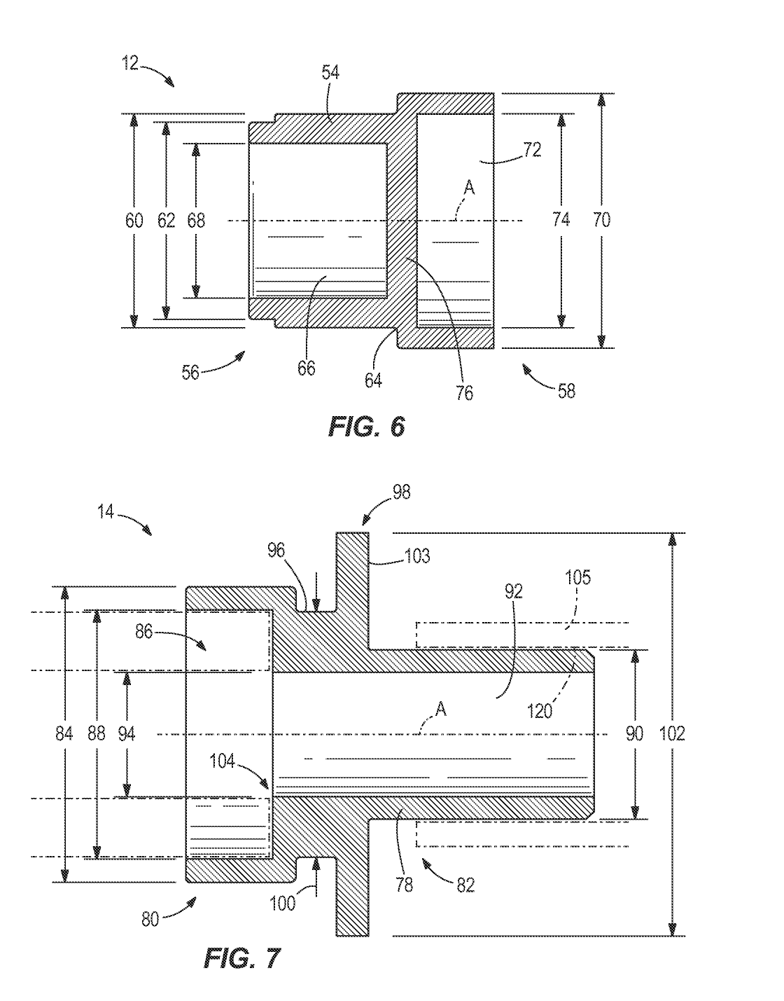

With respect to FIG. 6, the cap 12 includes a housing 54 formed from a plastic material, or other suitable material, and having a first portion 56 and a second portion 58. The cap 12 is substantially cylindrical. The first portion 56 of the cap 12 includes a first diameter 60 and a second diameter 62 having a step 64 therebetween. A substantially circular opening 66 having a uniform diameter 68 is included in the first portion 56 of the cap 12. The second portion 58 of the cap 12 includes a diameter 70 that is larger than both first and second diameters 60, 62 of the first portion 56 of the cap 12. The second portion 58 of the cap 12 includes a substantially circular opening 72 having a uniform diameter 74. The opening 72 is sized to couple to the first end 18 of the filter assembly 10. Therefore, the opening 72 in the second portion 58 of the cap 12 receives the first unthreaded portion 42 of the core 22 which is surrounded by the mesh overlay 24, described above. The cap 12 also includes a wall or partition 76 that separates the first portion 56 of the cap 12 from the second portion 58 of the cap 12. The core 22 and mesh overlay 24 can be press fit into the cap 12 or the cap can be bonded or otherwise attached. In still other constitutions, the cap 12 is molded into position.

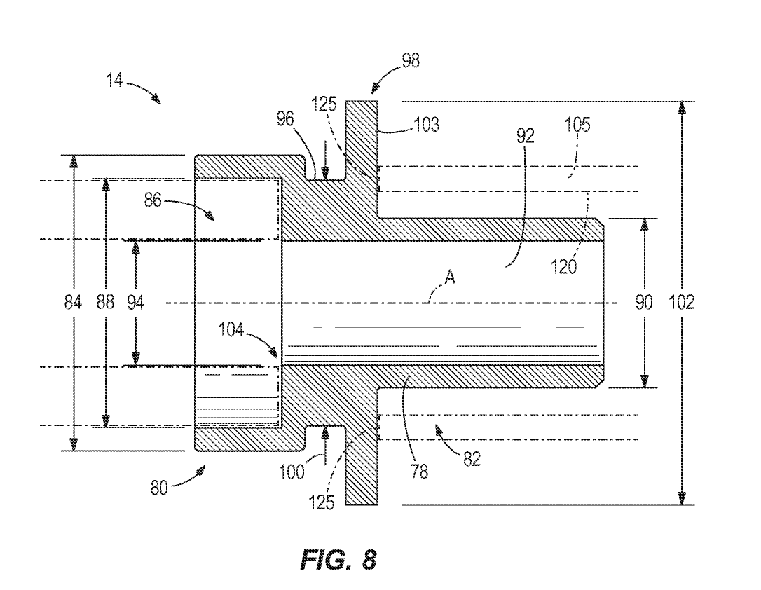

With reference to FIG. 7, the adaptor 14 includes a housing 78 formed from a plastic material, or other suitable material, and includes a first portion 80 and a second portion 82. The adaptor 14 is substantially cylindrical. The first portion 80 has a diameter 84 and defines a first opening 86. The first opening 86 is substantially cylindrical with a uniform diameter 88, and is sized to receive the second end 20 of the filter assembly 10 thereby surrounding the second unthreaded portion 44 of the core 22 enclosed within the mesh overlay 24. The second portion 82 of the adaptor 14 has a second or outside diameter 90, which may be smaller than the first diameter 88, and defines a second opening 92. The second opening 92 is substantially cylindrical with a uniform diameter 94 that is smaller than the diameter 88 of the first opening 86. The core 22 and mesh overlay 24 can be press fit into the adaptor 14 or the adaptor can be bonded or otherwise attached. In still other constructions, the adaptor 14 is molded into position.

Further with respect to FIG. 7, the adaptor 14 includes a recess 96 and a resilient flange 98 between the first and second portions 80, 82 of the housing 78. The recess 96 is between the first portion 80 of the housing 78 and the flange 98. The recess 96 includes a diameter 100 smaller than the diameter 84 of the first portion 80 and larger than the outside diameter 90 of the second portion 82 of the adaptor 14. The flange 98 is positioned between the recess 96 and the second portion 82. An outside flange diameter 102 of the flange 98 defines the largest diameter of the filter assembly 10. The flange 98 defines an annular planar surface 103 that is oriented substantially normal to the axis A when the adaptor 14 is attached to the remainder of the filter assembly 10.

In operation, the filter assembly 10 is installed into a tool having a conduit (not shown) that houses the filter assembly 10. Because tool conduits have a variety of sizes, the resilient flange 98 enables the filter assembly 10 to be compatible with a plurality of tools. The flange 98 allows the adaptor 14 to generate a fluidic seal with conduits of different sizes.

FIG. 7 also demonstrates that the openings 86, 92 extend through the adaptor 14 and extend the main channel 32. The first and second openings 86, 92 are in fluid communication with the main channel 32 of the core 22 thereby preserving the channel 32. When assembled, the second end 20 of the core abuts an internal step 104 such that the outlet of the channel 32 is positioned adjacent one end of the second opening 92. In the preferred constructions, the diameter 92 is similar to the diameter of the channel 32.

To assemble the filter assembly, the core is first formed using any suitable process or processes. The mesh overlay is then positioned around the core. In one construction, the cap and the adaptor are then molded onto the core and mesh overlay to complete the assembly. In other constructions, the mesh overlay is first connected to itself to form a tube having the core disposed therein. The cap and the adapter are then attached to the mesh overlay and the core using a suitable attachment method (e.g., thermal bonding, adhesives, welding, brazing, etc.) to complete the assembly.

In operation, the filter assembly is disposed within a paint supply such that paint surrounds the exterior of the assembly. The adaptor is coupled to a feed line 105 that extends to a paint gun, a pump, a sprayer or another device. The suction side of the pump is in fluid communication with the filter assembly, via the feed line such that during pump operation, a vacuum or low pressure region is produced within the channel 32. The low pressure draws paint through the apertures in the mesh overlay and through the openings 38 in the core. As the paint passes through the mesh overlay, particles larger than the mesh opening are blocked from entry.

In preferred constructions, the diameter 90 is sized to fit closely within the feed line 105, or component on the end of the feed line 105, to form a seal. Thus, in arrangements in which an inside diameter 120 of the feed line is about the same diameter as the outside diameter 90, the feed line 105 and the adapter cooperate to form a radial seal therebetween. The size difference between the adapter and the feed line can vary depending on many factors including suction pressure and the resilience of the various components. However, in most applications, the inside diameter should be no more than twenty percent smaller than the outer diameter 90 in which case the feed line 105 will expand to receive the adapter and no more than twenty percent larger than the outside diameter. Sizes within this range can be considered about the same for purposes of forming a radial seal.

In arrangements in which the feed line 105 is too large to form a seal (e.g., about 20 percent larger than the outside diameter 90). The adapter is still capable of forming a seal. As illustrated in FIG. 8, the feed line 105 includes a substantially annular end 125 that contacts the annular surface 103 to form an axial seal therebetween. As suction is applied, the adapter is pulled into further engagement with the end 125 of the feed line to improve the seal.

In some constructions, the outside diameter 90 and the inside diameter 120 of the feed line 105 are such that both a radial seal and an axial seal can be formed further enhancing the operation of the filter assembly 10.

It should be noted that while the filter assembly 10 has been described as being used with a paint gun or to filter paint, the filter assembly 10 could be used with other components and could filter other fluids such as stain, sealers, and the like.

What is claimed is:

1. A filter element for a paint sprayer having a feed line, the filter element comprising:
a core defining a first end, a second end, and a central portion extending along an axis between the first end and the second end, the central portion including a central aperture closed at the first end and open at the second end and a plurality of openings that extend through the core to the central aperture;
a mesh member surrounding the central portion; and
an adapter coupled to the second end and including a flowpath therethrough, the adapter including an outer cylindrical surface and an annular surface, the annular surface operable to engage an end of the feed line such that the adapter is operable to form an axial seal between the adapter and the feed line.

2. The filter element of claim 1, wherein the core includes a threaded portion that interconnects an outermost end of the plurality of openings.

3. The filter element of claim 1, wherein the mesh member wraps around the core portion and defines an overlap portion that extends along the axis between the first end and the second end.

4. The filter element of claim 1, wherein the mesh member includes a first plurality of apertures having a first size and a second plurality of apertures having a second size that is smaller than the first size, and wherein the second plurality of apertures are disposed adjacent the first end and the second end and the first plurality of apertures are disposed between the first end and the second end.

5. The filter element of claim 1, wherein the outer cylindrical surface defines an outside diameter and wherein the outer cylindrical surface and the feed line cooperate to define a radial seal when an inside diameter of the feed line is about equal to the outside diameter.

6. The filter element of claim 5, wherein the annular surface extends from the outside diameter to an outside flange diameter that is larger than the outside diameter, and wherein the annular surface and the end of the feed line cooperate to define the axial seal when the inside diameter of the feed line is substantially larger than the outside diameter.

7. A filter element for use with a plurality of different-sized feed lines, the filter element comprising:
a cylindrical filter including a closed end, an open end, and a central portion between the closed end and the opened end; and
an adapter coupled to the second end, the adapter including an outer cylindrical surface having an outside diameter and an annular surface that extends from the outside diameter to an outside flange diameter, wherein the outer cylindrical surface and the feed line cooperate to form a radial seal when the feed line has an inside diameter that is substantially the same as the outside diameter, and wherein the annular surface and the feed line cooperate to form an axial seal when the inside diameter is larger than an inside diameter that is capable of forming a seal with the cylindrical surface.

8. The filter element of claim 7, wherein the cylindrical filter includes a core portion having a central aperture operable to direct fluid along a longitudinal axis toward the open end and a plurality of substantially radial openings that include an end that intersects the central aperture.

9. The filter element of claim 8, wherein the core portion includes a threaded portion that interconnects an outermost end of each of the plurality of substantially radial openings.

10. The filter element of claim 8, wherein the cylindrical filter includes a mesh member wrapped around the core portion, and wherein the mesh member defines an overlap portion that extends along the longitudinal axis between the closed end and the open end.

11. The filter element of claim 10, wherein the mesh member includes a first plurality of apertures having a first size and a second plurality of apertures having a second size that is smaller than the first size, and wherein the second plurality of apertures are disposed adjacent the closed end and the open end, and the first plurality of apertures are disposed between the closed end and the open end.

12. A filter element for use with a first paint sprayer having a first feed line and a second paint sprayer having a second feed line, the first feed line having a first inside diameter that is different than a second inside diameter of the second feed line, the filter element comprising:
a core defining a first end, a second end, and a central portion extending along an axis between the first end and the second end, the central portion including a central aperture closed at the first end and open at the second end and a plurality of openings that extend through the core to the central aperture; and
an adapter coupled to the second end and including a flowpath therethrough, the adapter including an outer cylindrical surface having an outside diameter and an annular surface that extends from the outside diameter to an outside flange diameter, wherein the first inside diameter is such that the first feed line and the outer cylindrical surface cooperate to define a radial seal, the second inside diameter being larger than the first inside diameter and not sealingly engageable with the outer cylindrical surface, and wherein an end of the second feed line sealingly engages the annular surface to form an axial seal between the second feed line and the adapter.

13. The filter element of claim 12, wherein the core includes a threaded portion that interconnects an outermost end of each of the plurality of openings.

14. The filter element of claim 12, further comprising a mesh member surrounding the central portion.

15. The filter element of claim 14, wherein the mesh member wraps around the core portion and defines an overlap portion that extends along the axis between the first end and the second end.

16. The filter element of claim 14, wherein the mesh member includes a first plurality of apertures having a first size and a second plurality of apertures having a second size that is smaller than the first size, and wherein the second plurality of apertures are disposed adjacent the first end and the second end and the first plurality of apertures are disposed between the first end and the second end.

17. The filter element of claim 12, wherein the first feed line and the adapter cooperate to define the radial seal when the first inside diameter is about equal to the outside diameter.

18. The filter element of claim 17, wherein the second feed line and the adapter cooperate to define the axial seal when the second inside diameter is substantially larger than the outside diameter.
